(19) United States
(12) Patent Application Publication
(10) Pub. No.: US 2015/0356703 A1
(43) Pub. Date: Dec. 10, 2015

(54) ARRANGING A TRANSPORT SERVICE BASED ON COMPUTED VECTORS ASSOCIATED WITH SERVICE PROVIDERS

(71) Applicant: Uber Technologies, Inc., San Francisco, CA (US)

(72) Inventors: David Frederick Ellis, Sunnyvale, CA (US); Thuan Quang Pham, San Jose, CA (US); Hungyu Henry Lin, Saratoga, CA (US); Scott Munro, San Francisco, CA (US)

(21) Appl. No.: 14/301,218

(22) Filed: Jun. 10, 2014

(51) Int. Cl. G06Q 50/30; G06Q 10/06

(52) U.S. Cl. CPC G06Q 50/30; G06Q 10/063118

(57) ABSTRACT

A system and method for arranging a transport service is described. A server can determine, for each driver device of a plurality of driver devices in a given area, a first vector for that driver device based, at least in part, on a position of each client device of a set of client devices in the given area relative to that driver device. A request for transport service is received from a client device from the set of client devices. The server can determine, for each driver, a second vector for that driver based on the first vector and a position of the requesting client. A driver device is selected from the plurality of driver devices to perform the transport service based, at least in part, on the second vectors of the plurality of driver devices.

### BACKGROUND OF THE INVENTION

On-demand service systems exist that arrange for services to be provided for a user by a service provider. In one example, an on-demand service system can select a service provider for a requesting user through the use of mobile computing devices. For example, the requesting user can operate a mobile computing device to make a request for an on-demand service, and the system can select a service provider based on data received from devices operated by service providers.

### BRIEF DESCRIPTION OF THE DRAWINGS

FIG. 1 illustrates an example system to arrange an on-demand service, under an embodiment.

FIGS. 2A through 2F are example diagrams illustrating computed vectors for service providers, according to some embodiments.

FIGS. 3A and 3B illustrate example methods for arranging an on-demand service for a client operating a client device, according to some embodiments.

FIG. 4 is a block diagram that illustrates a computer system upon which embodiments described herein may be implemented.

FIG. 5 is a block diagram that illustrates a mobile computing device upon which embodiments described herein may be implemented.

### DETAILED DESCRIPTION

Examples described herein provide for an on-demand service system to arrange for a service to be provided for a user based on computed vectors associated with service providers in a given area. A computed vector can be representative of an amount of force (e.g., electrostatic or gravitational force) that pushes or pulls a service provider in a particular direction. For example, when the on-demand service system receives a request for the service from a client device in a given area, the on-demand service system can compute vectors associated with service providers based on location information of computing devices in the given area. Based on the computed vectors, the on-demand service system can select a service provider for a user of that client device.

According to some examples, the service system can continuously (e.g., periodically or intermittently) compute a first set of vectors for available service providers in a given area. For each service provider device of a plurality of service provider devices in the given area, the service system can compute a first vector for that service provider device based, at least in part, on a position of each client device of a set of client devices in the given area relative to that service provider device. Each first vector can have a first magnitude and a first direction from a position of that service provider device. The service system can continuously determine a first vector for each service provider device (e.g., at a time t1, then at a subsequent time t2, and so forth) as one or more service providers and/or one or more clients in the given area can move and change positions continuously. As an addition or an alternative, for each service provider device, the service system can compute the first vector based also on a position of the other service provider devices in the given area.

When the service system receives a request for an on-demand service from a client device of the set of client devices in the given area, the service system can compute a second set of vectors for the available service providers in the given area. For example, for each service provider device of the plurality of service provider devices, the service system can compute a second vector for that service provider based on the first computed vector for that service provider device and a position of the requesting client device. Each second vector can have a second magnitude and a second direction from the position of that service provider device. The service system can select a service provider to provide the on-demand service for the requesting client that operates the requesting client device based, at least in part, on the second magnitudes of the second vectors of the plurality of service provider devices.

Depending on implementation, the service system can rank at least a set of service provider devices of the plurality of service provider devices based, at least in part, on the second magnitudes of the second vectors. The service system can also rank at least the set of service provider devices based on one or more other factors, such as, for example, a distance between each of the service provider devices and the requesting client device, an estimated time of arrival for each of the service provider devices to the requesting client device, a rating of each of the service providers that operates a respective service provider device, and/or other factors. The service system can then select the service provider device having the highest ranking to perform the on-demand service for the requesting client.

As used herein, a client device, a service provider device (e.g., a driver device), and/or a computing device, in general, refer to devices corresponding to cellular devices or smartphones, personal digital assistants (PDAs), laptop computers, tablet devices, etc., that can provide network connectivity and processing resources for communicating with the system over one or more networks. A driver device can also correspond to a taxi meter, other metering devices of a transit object, or custom hardware, etc. The client device and/or the driver device can also operate a designated service application configured to communicate with the on-demand service system.

Still further, while some examples described herein relate to transport services, the service system can enable other on-demand location-based services (e.g., a food truck service, a delivery service, an entertainment service, etc.) to be arranged between individuals and service providers. For example, a user can request an on-demand service, such as a delivery service (e.g., food delivery, messenger service, food truck service, or product shipping service, etc.) or an entertainment service (e.g., mariachi band, string quartet, etc.) using the service system, and the service system can select a service provider, such as a driver, a food provider, a band, etc., to provide the requested on-demand service for the user.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers or switches), and tablet devices. Memory, processing, and network resources may all be used in connection with the establishment, use, or performance of any embodiment described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples discussed herein can be carried and/or executed. In particular, the numerous machines shown with examples herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

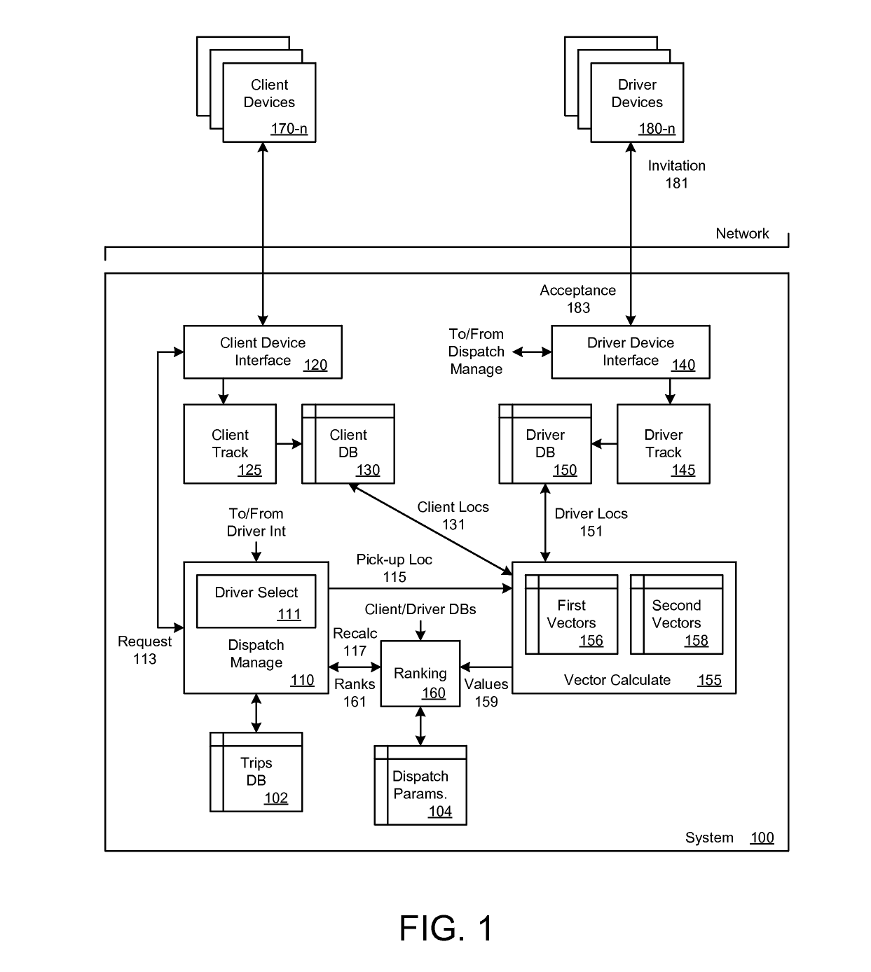

FIG. 1 illustrates an example system to arrange an on-demand service, under an embodiment. In examples described herein, an on-demand service system can perform a plurality of vector calculations for purposes of selecting a suitable service provider for a requesting client while furthering or attempting to further the overall efficiency of the system.

According to an example, system 100 includes a dispatch manage 110, a client device interface 120, a client track component 125, a driver device interface 140, a driver track component 145, a vector calculate 155, and a ranking component 160. System 100 can also include one or more databases, such as a trips database 102, a dispatch parameters database 104, a client database 130, and a driver database 150. A plurality of client devices 170 and a plurality of driver devices 180 (e.g., service provider devices) can communicate with system 100 over one or more networks using, for example, respective designated service applications (e.g., service applications that communicate with system 100) that operate on the client devices 170 and the driver devices 180. The components of system 100 can combine to perform vector calculations for driver devices 180 for purposes of arranging a transport service for a requesting client (operating a respective client device 180). Logic can be implemented with various applications (e.g., software) and/or with hardware of a computer system that implements system 100. In addition, although the vector calculate 155 and the ranking component 160 are shown as separate components in FIG. 1, the components can be a part of or included with the dispatch manage 110 depending on implementation. Similarly, other components, such as the client track component 125 and the driver track component 145, and/or the databases of system 100, can be a part of or included with different components of system 100.

Depending on implementation, one or more components of system 100 can be implemented on network side resources, such as on one or more servers (e.g., datacenters). System 100 can also be implemented through other computer systems in alternative architectures (e.g., peer-to-peer networks, etc.). As an addition or an alternative, some or all of the components of system 100 can be implemented on client devices, such as through applications that operate on the client devices 170 and/or the driver devices 180. For example, a client application, such as a designated service application, can execute to perform one or more of the processes described by the various components of system 100. System 100 can communicate over one or more networks, via a network interface (e.g., wirelessly or using a wireline), to communicate with one or more client devices 170 and one or more driver devices 180.

System 100 can communicate, over one or more networks, with client devices 170 and driver devices 180 using a client device interface 120 and a device interface 140, respectively. The device interfaces 120, 140 can each manage communications between system 100 and the respective computing devices 170, 180. In some examples described herein, the client devices 170 and the driver devices 180 can individually operate a service application that can interface with the device interfaces 120, 130, respectively, to communicate with system 100. According to some examples, the applications can include or use an application programming interface (API), such as an externally facing API, to communicate data with the device interfaces 120, 140. The externally facing API can provide access to system 100 via secure access channels over the network through any number of methods, such as web-based forms, programmatic access via restful APIs, Simple Object Access Protocol (SOAP), remote procedure call (RPC), scripting access, etc.

According to an example, a plurality of clients can operate a plurality of client devices 170 in a given area or region (e.g., a region corresponding to a neighborhood, a town, a city, a metropolitan area, a county, a state, a country, etc.). Each client device 170 can run a service application that enables the client device 170 to communicate with system 100 via the client device interface 120. For example, once a client turns on or launches the service application on her client device 170, the service application can periodically ping or transmit information to system 100 via the client device interfaces 120 (e.g., every two seconds, every three seconds, etc.). The transmitted information, herein referred to as client information, can include (i) a client or client device identifier (ID), (ii) a status or state of the client (e.g., has requested transport or not, is currently being transported), (iii) location information corresponding to the current location of the client device at or around the time the location information is transmitted (e.g., a GPS data point, such as a latitude and a longitude, determined using a GPS component of the client device), and/or (iv) a timestamp of the location information or a timestamp when the client information is provided.

The client track component 125 can continuously (and asynchronously) receive client information from multiple client devices 170 and continuously update the client database 130 to include real-time or close to real-time client data. For example, because each of a plurality of client devices 170 can individually periodically transmit client information to the client track component 125, the client track component 125 can continuously receive client information and continuously update the client database 130. For each client operating a client device 170, the client track component 125 can update an entry in the client database 130 with client information from the respective client device 170 (e.g., using a client or client device ID).

Similarly, a plurality of drivers can operate a plurality of driver devices 180 in the given area or region. Each driver device 180 can run a service application that enables the driver device 180 to communicate with system 100 via the driver device interface 140. In one example, by operating the service application, individual driver devices 180 can receive information or messages from system 100 and can periodically transmit information to system 100 via the driver device interface 140 (e.g., every three seconds, every four seconds, etc.). The transmitted information, herein referred to as driver information, can include (i) a driver or driver device identifier (ID), (ii) a status or state of the driver with respect to a transport service (e.g., on duty and available for dispatch, on duty but currently en route to pick up a client, on duty but currently providing a transport service, or off duty), (iii) location information corresponding to the current location of the driver device at or around the time the location information is transmitted (e.g., a GPS data point, such as a latitude and a longitude, determined using a GPS component of the driver device), and/or (iv) a timestamp of the location information or a timestamp when the driver information is provided.

In addition, the driver track component 145 can continuously (and asynchronously) receive driver information from multiple driver devices 180 and continuously update the driver database 150 to include real-time or close to real-time driver data. For example, because each of a plurality of driver devices 180 can individually periodically transmit driver information to the driver track component 145, the driver track component 145 can continuously receive driver information and continuously update the driver database 150. For each driver operating a driver device 180, the driver track component 145 can update an entry in the driver database 150 with driver information from the respective driver device 180 (e.g., using a driver or driver device ID).

Depending on implementation, system 100 can continuously update the client database 130 and the driver database 150 with real-time or close to real-time client information and driver information, respectively, for different geographic areas or regions. As such, multiple client databases 130 and multiple driver databases 150 can be used by system 100 for multiple designated or specified geographic areas. For example, a first client database 130 and a first driver database 150 can be used for San Francisco, Calif., while a second client database 130 and second driver database 150 can be used for Los Angeles, Calif.

For a given area, the vector calculate 155 can access the client database 130 and the driver database 150, and programmatically compute vectors for a plurality of driver devices 180 in the given area based on the clients' location information 131 and drivers' location information 151. For illustrative simplicity, reference made to “driver devices” are for driver devices that are active (e.g., have the service application running) and that are being operated by drivers that are available to provide transport services (e.g., on duty and not yet assigned to provide transport services). The vector calculate 155 can determine which driver devices 180 are active and available based on the state information of the drivers in the driver database 150 for a given area. Similarly, reference made to “client devices” are for client devices that are active (e.g., have the service application running) and that are being operated by clients that have not yet been assigned transport services. The vector calculate 155 can programmatically calculate vectors associated with driver devices 180 for purposes of enabling system 100 to arrange transport services using computed vectors.

For example, each of a plurality of driver devices 180 in a given area can be represented by a GPS data point (e.g., a latitude, a longitude) in a coordinate system of latitudes and longitudes (e.g., an X-Y coordinate system with X corresponding to latitude and Y corresponding to longitude). Similarly, each of a set of client devices 170 in the given area can be represented by a GPS data point in the coordinate system. Based on the positions of the driver devices 180 and the client devices 170, system 100 can compute a first vector for each of the plurality of driver devices 180 in the given area. This first vector can be representative of an amount of force that pushes or pulls that driver device 180 in a particular direction from the coordinate position of that driver device.

In one example, each driver device 180 can be represented as a massless particle that is attracted to a client device 170 (and that has an insignificant mass as compared to the client devices 170), which can be represented as another particle, in a gravitational force metaphor or model. Based on the positions of the driver devices 180 and the client devices 170 in the given area, each first vector for a driver device 180 can indicate the magnitude and direction that the driver device 180 would be pushed or pulled to move in as a result of attractions to client devices 170 (e.g., where the magnitude or force=Gm1m2/r̂2). In another example, each driver device 180 can be represented as a negative particle (e.g., an electron) that repels other driver devices 180 and that is attracted to a client device 170, which can be represented as a positive particle (e.g., a proton), in an electrostatic force metaphor or model. In such an example, because the driver devices 180 repel each other, each first vector for a driver device 180 can indicate the magnitude and direction that the driver device 180 would be pushed or pulled to move in as a result of attractions to client devices 170 and as a result of repulsions to other driver devices 180. In either examples, system 100 can use the computed vectors as at least one factor in determining which driver device 180 to select in order to arrange a transport service for a requesting client.

Depending on variations, for each driver device of a plurality of driver devices 180 in a given area (e.g., a city area or a portion of a city area), the vector calculate 155 can compute a first vector for that driver device based on (i) a position of at least one client device of a set of client devices 170 (e.g., a position of each client device of the set of client devices 170) in the given area relative to that driver device, and/or (ii) a position of one or more other driver devices 180 in the given area relative to that driver device. The computed first vectors can be stored with associated driver device IDs in a first vectors database 156 included with or in communication with the vector calculate 155. For example, if there are ten driver devices in the given area (e.g., D1, D2, D3, . . . D10), the vector calculate 155 can compute a first vector for each of the ten driver devices. Each first vector can have a first magnitude and a first direction starting from a position or location of the corresponding driver device, which can be represented by a latitude value and a longitude value, for example.

The vector calculate 155 can compute the first vector (e.g., periodically or intermittently) for each of the plurality of driver devices 180 in a given area. For example, the vector calculate 155 can periodically compute the first vector (e.g., every two seconds, every five seconds, etc.) and/or compute the first vector when there is a change in (i) a number of active client devices in the given area, (ii) a number of available driver devices in the given area, (iii) a location of active client devices in the given area, and/or (iv) a location of active driver devices in the given area. The number of active client devices in a given area may change if a new client launches the service application using a client device in the given area (e.g., joins the group of active clients), and/or if an existing client leaves the group of active clients (e.g., the client closes or hides the service application, or the client is no longer available because she has been arranged a transport by system 100). Similarly, the number of available driver devices in the given area may change if a new driver indicates via input on the service application that he is on-duty and available, and/or if an existing driver indicates via input on the service application that she is off-duty or has accepted an invitation for a transport service.

For example, because a first vector for a driver device is computed based, at least in part, on a position of each client device of a set of client devices 170 in the given area relative to that driver device, when such change(s) discussed above occur, the first vector can be recalculated to reflect the change(s). Similarly, the first vectors for the other driver devices 180 in the given area can be recalculated to reflect the new change(s). In addition, for each of the plurality of driver devices 180 in a given area, the first vector can also be based on a position of other driver devices 180 in the given area (relative to that driver device). As such, changes to the position of driver devices 180 (as drivers typically are not stationary and constantly move in the given area) can also effect the first vector (e.g., the magnitude and/or the direction of the first vector) of individual driver devices 180.

Depending on implementation, the vector calculate 155 can compute, for each driver device of the plurality of driver devices 180 in a given area, the first vector by (i) calculating a set of individual vectors for that driver device, with each individual vector being based on a distance between the position of a client device in the set of client devices and the position of that driver device, and (ii) adding together each individual vector to result in the first vector for that driver device. For example, for a driver device (D1), if there are three client devices (e.g., C1, C2, C3) in the given area, the vector calculate 155 can compute three individual vectors, with one of the individual vectors (Vector1) being based on a distance between C1 and D1, another vector (Vector2) being based on a distance between C2 and D1, and a third vector (Vector3) being based on a distance between C3 and D1. The magnitude of each individual vector can be based on the respective distances, and the direction of each individual vector can point from the position of that driver device in a line towards the position of the respective client device. The vector calculate 155 can then sum or add together the set of individual vectors (Vector1, Vector2, Vector3) for that driver device (D1) to result in the first vector. Similarly, the vector calculate 155 can compute three individual vectors for another driver device (D2) of the plurality of driver devices 180, then add together the set of individual vectors for that driver device (D2), and so forth for each driver device in the plurality of driver devices 180.

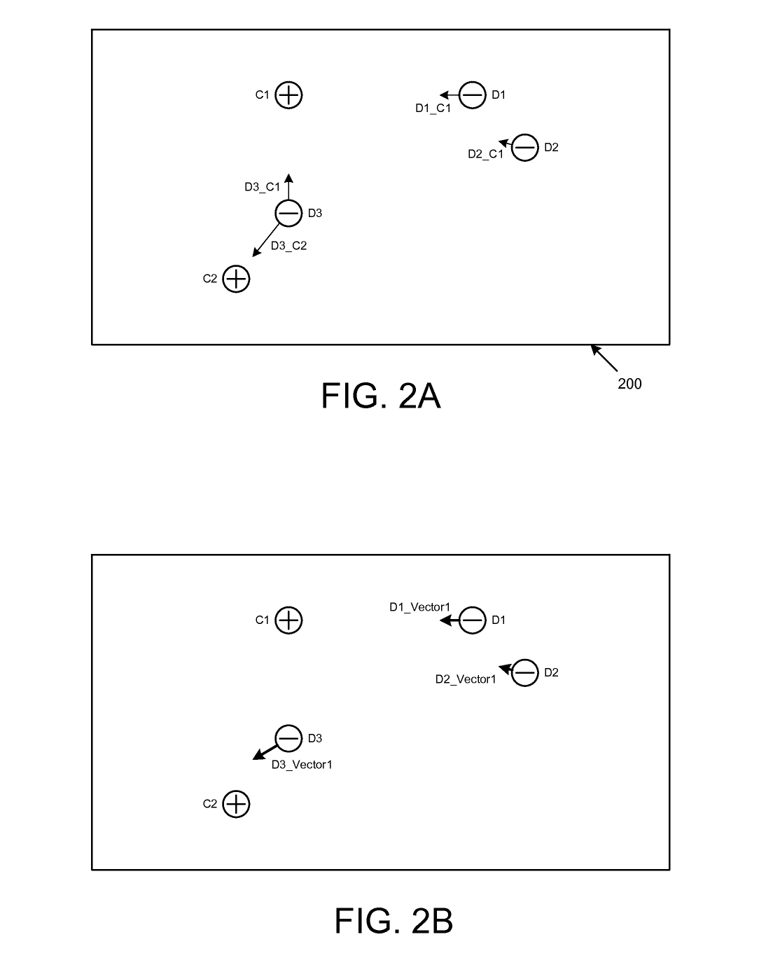

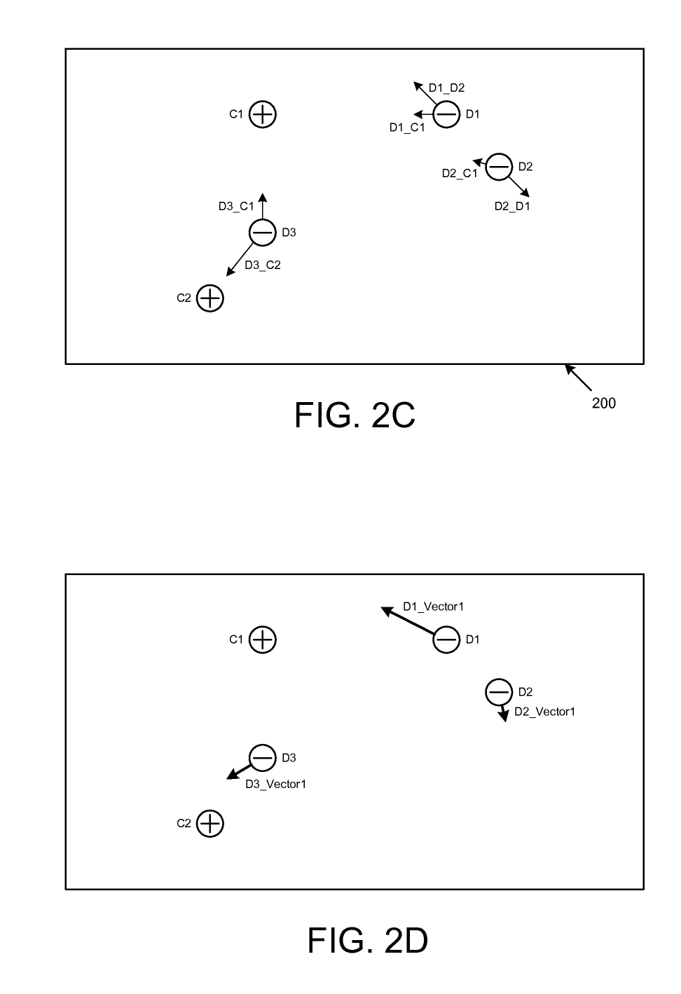

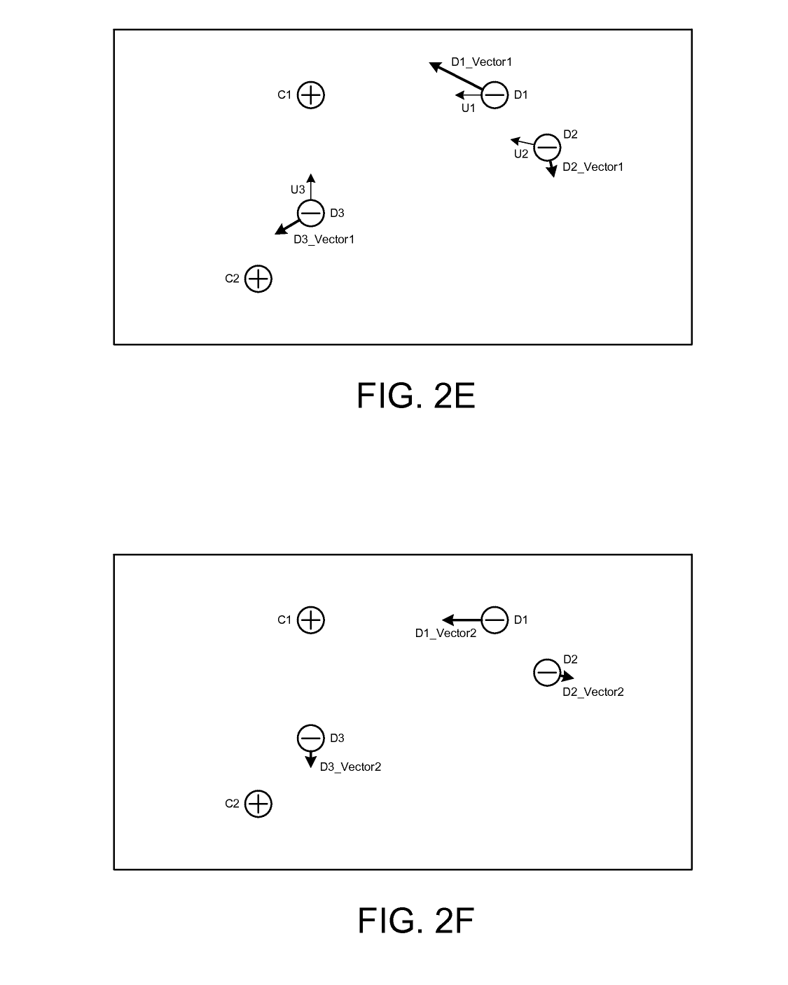

In some examples, a magnitude of an individual vector between a driver device 180 and a client device 170 can be determined using the inverse square law, in which the magnitude (e.g., which is representative of a gravitational or electrostatic force) is inversely proportional to the square of the distance between the two devices. As such, some client devices 170 that are a certain distance away from a driver device 180 would have a negligible effect on computing the first vector of that driver device 180. For example, referring to FIG. 2A, in a given area 200, there can be three driver devices D1, D2, D3, and two client devices C1, C2. As discussed, at a given time, the vector calculate 155 can compute, for each of the plurality of driver devices, a first vector by computing a set of individual vectors and adding together each individual vector. For D1, the vector calculate 155 can determine an individual vector, vector D1_C1, based on the current position of D1 and the position of C1. Vector D1_C1 can have a magnitude based on the inverse square law of the distance between the two positions (not to scale), and have a direction from the position of D1 towards the position of C1.

According to an implementation, while another client device C2 is also in the given region 200, the vector calculate 155 may programmatically determine that C2 is more than a threshold (e.g., user configurable) distance away from D1, so that based on the inverse square law, the magnitude of a vector D1_C2 would be negligible. Thus, depending on variations, the vector calculate 155 may bypass performing additional vector calculations for such client devices that are further than the threshold distance away from a driver device, or may perform the vector calculation and determine that the individual vector for a driver device is negligible (e.g., close to a zero magnitude). Accordingly, for illustrative purposes, in FIG. 2A, no vector D1_C2 for D1 (that is based on the position of C2) is shown for D1. In such case, a first vector for a driver device can be based on one or more client devices of a set of client devices in the given area (as opposed to each client device) that are within a specified or threshold distance of the driver device.

Similarly, the vector calculate 155 can determine a set of individual vectors for D2 and also for D3. For D2, the vector calculate 155 can determine an individual vector, vector D2_C1, based on the position of D2 and the position of C1. However, again, in FIG. 2A, no vector D2_C1 is provided (or in one example, is not calculated) for D2 with respect to C2, as C2 is more than a threshold distance away from D2. For D3, the vector calculate 155 can determine a set of individual vectors, vector D3_C1, in the direction from D3 to C1, and vector D3_C2, in the direction from D3 to C2. The vector calculate 155 can determine the magnitudes of vector D3_C1 and vector D3_C2 for D3 using the inverse square law and the distances between C1 and C3, and C2 and C3, respectively. As illustrated in FIG. 2A (although not precisely to scale in the exemplary illustration), the magnitude of vector D3_C2 is greater than the magnitude of vector D3_C1 as C2 is closer to D3 than C1. Similarly, the magnitude of vector D1_C1 is greater than the magnitude of vector D2_C1 as C1 is closer to D1 than D2. In some examples, FIG. 2A can represent the gravitational force metaphor or model in which the driver devices are defined as being nearly massless (e.g., as compared to the client devices) and do not influence each other.

After the vector calculate 155 computes a set of individual vectors for each driver device of the plurality of driver devices 180 in a given area, the vector calculate 155 can determine a first vector for each driver device by summing the individual vectors. Referring to FIG. 2B, for D1, the sum of the set of individual vectors (e.g., vector D1_C1 for D1) results in the first vector, labeled D1_Vector1. For D2, the sum of the set of individual vectors (e.g., vector D1_C1 for D2) results in the first vector, labeled D2_Vector1. For D3, the sum of the set of individual vectors (e.g., vector D3_C1 and vector D3_C2 for D3) results in the first vector, labeled D3_Vector1. As illustrated in FIG. 2B, the first vector D3_Vector1 for D3 represents the amount of force that the driver device D3 is being pushed or pulled and the direction of that force. The vector calculate 155 can store the computed first vectors with the corresponding driver devices IDs in the first vectors database 156.

As an addition or an alternative, for each of the plurality of driver devices 180, the vector calculate 155 can determine the first vector for that driver device based on both of (i) a position of at least one client device of a set of client devices 170 in the given area relative to that driver device, and (ii) a position of one or more other driver devices 180 in the given area relative to that driver device. For example, for a driver device, the vector calculate 155 can (i) compute a first set of individual vectors that are each based on a distance between the position of a client device in the set of client devices 170 and the position of that driver device, (ii) compute a second set of individual vectors that are each based on a distance between the position of another driver device in the plurality of driver devices 180 and the position of that driver device, and (iii) add together each of the first set of individual vectors and the second set of individual vectors to result in the first vector for that driver device.

For example, referring to FIG. 2C, at a given time, the vector calculate 155 can compute a first set of individual vectors for each of D1, D2, D3 in a given area 200. Like the example shown in FIG. 2A, for D1, the vector calculate 155 can determine or compute (i) vector D1_C1 for D1 based on the positions of D1 and C1, (ii) vector D2_C1 for D2 based on the positions of D2 and C1, and (iii) vectors D3_C1 and D3_C2 for D3 based on the positions of D3 and C1 and the positions of D3 and C2. Depending on implementation, as discussed above, other individual vectors based on positions of client devices with respect to driver devices may or may not be computed depending on whether the distances between those devices would render such individual vectors negligible (e.g., as a result of the inverse square law).

In addition, for the driver devices in the given area, the vector calculate 155 can determine individual vectors that are based on the positions of other driver devices in the given area. For example, for D1, the vector calculate 155 can determine an individual vector, vector D1_D2, that is representative of a force (e.g., repulsion force as opposed to attractive force) between two driver devices, D1 and D2. In some examples, FIG. 2C can represent the electrostatic force metaphor or model in which the driver devices repel each other as a result of being defined as having the same charge (e.g., negative charge). The direction of the vector D1_D2 is in the direction away from the position of D2 and can have a magnitude based on the inverse square law. Similarly, for D2, the vector D2_D1 can have the same magnitude based on the positions of D2 and D1, but is in the opposite direction than the vector D1_D2.

For D3, the vector calculate 155 can compute an individual vector based on the positions of D1 and D3, and an individual vector based on the positions of D2 and D3 and determine that the vectors are negligible, or bypass the vector calculation as a result of the distances between each of D1 and D3, and D1 and D2 being greater than a threshold distance (e.g., a same or different threshold distance than the threshold distance between a client device and a driver device). For each driver device in the given area 200, once the vector calculate 155 computes the first set of individual vectors (based on positions of client devices) and the second set of individual vectors (based on positions of other driver devices), as illustrated in FIG. 2C, the vector calculate 155 can sum together each of the individual vectors to determine a first vector for that driver device.

Referring to FIG. 2D, for D1, the sum of the first set of individual vectors and the second set of individual vectors results in the first vector, labeled D1_Vector1. For D2, the sum of the first set of individual vectors and the second set of individual vectors results in the first vector, labeled D2_Vector1. For D3, the sum of the first set of individual vectors and the second set of individual vectors results in the first vector, labeled D3_Vector1. Note that the first vectors for D1 and D2 in FIG. 2D are different than the first vectors for D1 and D2 in FIG. 2B, as a result of a different computational process performed by the vector calculate 155.

In either implementations, in some examples, because of the changes that can occur in real-time due to the movements of devices or the launching or closing of service applications, the vector calculate 155 can continuously recalculate or re-compute the first vectors of each driver device in the plurality of driver devices 180 using the most up-to-date information. For example, in FIGS. 2A and 2B, after computing the first vectors for the driver devices D1-D3 at time t=t1, each of the drivers may have moved along a street in a direction. As the driver track component 145 updates the driver database 150 with the driver information, the vector calculate 155 can access the driver database 150 with new updated driver locations 151 in order to determine the first vectors for the driver devices D1-D3 at a subsequent time t=t2 (e.g., 500 ms later, 1 s later, etc.). The vector calculate 155 can continuously compute the first vectors and store the first vectors in the first vectors database 156.

Referring back to FIG. 1, when a client operating one of the client devices 170 in the given area makes a transport request 113 for a transport service (the “requesting client device”), the dispatch manage 110 can receive the request 113 via the client device interface 120. In another example, the dispatch manage 110 can detect that a request 113 has been made by accessing the client database 130. The request 113 can include, for example, the client ID, the requesting client device ID, a pickup location, and/or a destination location. The dispatch manage 110 can create a record for the transport service (e.g., a trip record) and store the trip record with the client ID, the requesting client device ID, the pickup location, and/or the destination location in the trips database 102.

In addition, when the dispatch manage 110 receives the request 113, the dispatch manage 110 can provide the client ID (or client device ID) and/or the pickup location 115 of the transport service to the vector calculate 155. As an alternative or an addition, the dispatch manage 110 can provide the client ID (or client device ID) of the requesting client device and the vector calculate 155 can access the client database 130 or the trips database 102 to determine the pickup location 115. After or in response to system 100 receiving the request 113, the vector calculate 155 can determine or compute, for each driver device of the plurality of driver devices 180, a second vector based on the first vector of that driver device and based on a position of the requesting client device. Each second vector can have a second magnitude and a second direction from a position of the respective driver device 180. Typically, the pickup location 115 is substantially close to the current position of the requesting client device. Thus, in some examples, the pickup location 115 (e.g., the latitude and longitude) can be used as the position of the requesting client device.

According to some examples, the vector calculate 155 can compute the second vectors for the plurality of driver devices 180 in the given area by determining a unit vector (e.g., having a magnitude of 1), or another vector having a predetermined magnitude, for each of the plurality of driver devices 180. For each driver device, the unit vector can point in a direction from the position of that driver device to the position of the requesting client device. For example, referring to FIG. 2E, the first vectors, D1_Vector1, D2_Vector1, D3_Vector3, for the three driver devices, D1, D2, D3, respectively, are illustrated in the diagram (the same vectors as shown in FIG. 2D). If, for example, the client device C1 made the request 113 (e.g., is the requesting client device), the vector calculate 155 can determine a unit vector for each of the driver devices, D1, D2, D3, based on the position of C1.

In this example, the unit vector U1 is determined for D1, the unit vector U2 is determined for D2, and the unit vector U3 is determined for D3 (shown in the respective directions in FIG. 2E for illustrative purposes). The vector calculate 155 can also, for example, access the first vectors database 156 to determine the first vectors (shown in FIGS. 2D and 2E) for the driver devices. The vector calculate 155 can then determine the second vector for each driver device in the given area by performing a vector computation using the respective first vector for that driver device and the unit vector for that driver device.

According to an example, for each driver device of a plurality of driver devices in the given area, the vector calculate 155 can perform a multiplication process (e.g., a vector dot product computation) of the first vector and the unit vector to determine a scalar (a value) or magnitude of the second vector for that driver device. The second vector for a driver device can have the determined magnitude and point in the same direction as the unit vector used to compute the magnitude of the second vector. For example, as illustrated in FIG. 2F, the vector calculate 155 can determine for the second vector, D1_Vector2, for D1, having a magnitude and having a direction as the unit vector, U2 of FIG. 2E.

For D2, the vector dot product computation of the first vector, D2_Vector1, and the unit vector, U2, results in a negative magnitude of the second vector (because of the directions of the first vector and the unit vector). Because a negative magnitude is equivalent to a positive magnitude in the opposite direction, for D2, the second vector, D2_Vector2, points in an opposite (180 degrees) direction than that of the unit vector for D2 (see FIGS. 2E and 2F). Similarly, the vector calculate 155 can determine the second vector, D3_Vector2, for D3. Again, as a result of the directions of the first vector and the unit vector of D3 (see FIG. 2E), the second vector, D3_Vector2, for D3 also points in an opposite direction than that of the unit vector for D3. In some examples, the vector calculated 155 can store the second vectors for the driver devices in the given area in the second vectors database 158.

The magnitudes of the second vectors for the driver devices in the given area can be representative of which driver device is best suited (based on other devices in the given area) to provide the transport service for the requesting client device. Referring to FIG. 2F, although not to scale, when C1 is the requesting client device, the magnitude of D1_Vector2 of D1 is greater than the magnitudes of D2_Vector2 of D2 and D3_Vector3 of D3. Accordingly, based on the magnitudes of the second vectors, D1 would be the most suitable candidate for providing the transport service for C1, even though D3 is positioned closer (in distance) to C1 than D1. This can be a result of the positions of the devices in the given area and the vector computations based on either the gravitational or electrostatic force models. For example, because C2 is an active client device that is close to D3, the magnitudes of the second vectors can illustrate that it would be better to have D1 provide the transport service for C1 so that at a later time, if necessary, D3 can provide the transport service for C2. Such dispatch selection can prevent D3 from being selected for the requesting client C1, and therefore cause either D1 or D2, which are much further away from C2, to have to provide at a later time, if necessary, the transport service for C2. In this manner, using computed vectors to select a driver for providing transport service may enable system efficiency.

Referring back to FIG. 1, the vector calculate 155 can provide the values 159 (e.g., magnitudes) of the computed second vectors of the driver devices 180 to the ranking component 160. As an addition or an alternative, other information about the second vectors can be provided to the ranking component 160, such as the direction and/or the latitude (X) component and the longitude (Y) component that correspond to a second vector. According to some examples, the ranking component 160 can access a dispatch parameters database 104 to determine one or more rules or parameters that instruct the ranking component 160 how to rank at least a set (or all) of the driver devices in the given area.

The one or more rules or parameters can specify which factors (or signals) to use for performing a ranking of driver devices in the given area, and what weights are to be applied to the factors. In addition, the one or more rules or parameters can be user-configurable by a user of system 100 (e.g., adjust the weights, determine which factors to use to select a driver or rank drivers in a given area or system-wide). In some examples, the vector calculate 155 can access the dispatch parameters database 104 to determine how to perform vector calculations, to determine threshold distances (e.g., for bypassing vector calculations), etc. The ranking component 160 can also access the client database 130 and the driver database 150 for purposes of retrieving information about the requesting client and information about the drivers operating the driver devices 180 in the given area.

For example, the ranking component 160 can be instructed to use any of one or more factors to rank at least a set of driver devices (e.g., the top ten driver devices or all driver devices) of the plurality of driver devices 180 in the given region: The factors can include: (i) a value of each of the second vectors for the driver devices 180, (ii) a distance between each of the driver devices 180 and the requesting client device (e.g., Cartesian coordinate distance between two points), (iii) a distance of likely travel between each of the driver devices 180 and the requesting client device (e.g., based on map data), (iv) an estimated time of arrival for each of the driver devices 180 to the requesting client device, (v) a rating of each of the drivers that operates a respective driver device, (vi) favorite driver information of one or more drivers in the given area, if any, that is specified by the requesting client in the client's profile or account, (vii) hated driver information of one or more drivers in the given area, if any, that is specified by the requesting client in the client's profile or account, and/or (viii) other factors.

In addition, the ranking component 160 can be instructed to apply weights to the one or more factors in order to determine a ranking of driver devices in the given region. A weight can be an integer to multiply a value associated with a factor, or can be a percentage (where the weights taken together add up to 100%). As an example, if three factors are used to perform a ranking, such as (1) vector magnitudes, (ii) estimated time of arrival (ETA), and (iii) driver ratings, weights can be applied to each of the three factors to effect the ranking, such as 75% weight to vector magnitudes, 15% weight to ETA, and 10% weight to driver ratings. Of a plurality of driver devices 180 in a given area, the ranking component 160 can then perform a ranking operation by first pre-filtering out driver devices based on predefined thresholds (e.g., filter out driver devices that are outside of a predefined distance from the requesting client device or that are further than a predefined ETA from the requesting client device, etc.) so that only a set of the plurality of driver devices 180 are ranked. The set of driver devices 180 are then ranked as compared to each other using the weighted factors. Each driver can be provided a number, such as an integer, between a range of numbers (e.g., 0 to 100, where 100 is the highest ranking).

According to some examples, the ranking component 160 can also be instructed to provide bonus points for a factor to one or more drivers. As discussed, the ranking component 160 can access the client database 130 and the driver database 150. If a requesting client has specified in her profile one or more favorite drivers, then those drivers can be provided extra bonus points to effect their ranking (to be potentially even higher than the 100 point highest ranking). Similarly, if the requesting client has specified in her profile one or more disliked or hated drivers, then the points for those drivers can be reduced by a certain bonus amount. Other factors that bonus points can be applied to include recently joined or signed-up drivers (e.g., those drivers that have recently joined/subscribed to the transport service system) to potentially select those drivers more frequently for purposes of giving them a chance to learn and participate in the system.

After ranking the set of driver devices 180, the ranking component 160 can provide a ranking 161 to the driver select component 111 of the dispatch manage 110. The driver select component 111 can use the ranking 161 to identify the highest ranked driver or driver device for providing the transport service for the requesting client. Using the driver ID or the driver device ID of the highest ranked driver or driver device, the dispatch manage 110 can provide, to the driver device 180 of that driver, an invitation 181 via the driver device interface 140. The invitation 181 can be invite the driver to have the option to accept or decline the transport service for the user. In some examples, the invitation 181 can include the pickup location 115 of the requesting client, the client ID, and/or the ratings of the client, and can enable the driver to provide a response to accept or decline the invitation by providing input via the service application.

If the first selected driver rejects or declines the invitation 181, the rejection is received via the driver device interface 140, and the dispatch manage 110 determines that another driver has to be selected to provide the transport service for the user. Depending on implementation, the driver select 111 can identify the next driver with the next highest ranking in the ranking 161, and then provide an invitation 181 to the driver device 180 of that driver. The process can be repeated until a selected driver responds with an acceptance 183. As an addition or an alternative, the driver select 111 can provide a recalculation trigger 117 to cause the ranking component 160 to perform a new ranking 161 (without the driver device 180 that rejected the invitation 181), as real-time conditions (such as driver availability, driver locations) may have changed since the previous time the set of driver devices 180 were ranked. The driver select 111 can also cause the vector calculate 155 to recalculate the first vectors and/or the second vectors for the plurality of driver devices 180 in the given area (including or removing the driver device 180 that rejected the invitation 180 from the computations, depending on variations). Once a selected driver responds with an acceptance 183, the dispatch manage 110 can update the trip record for that transport service with the driver ID.

In this manner, system 100 can arrange a transport service for a requesting client in a given area by selecting a driver based, not only on information about that driver, but also on real-time or close to real-time conditions of other clients and other drivers in the given area. In examples described, computed vectors can be based on an electrostatic or gravitational force model to take into account other available drivers in the given area and other clients that are operating the service application. Because a computed vector can represent a magnitude and a direction in which a driver device should be moved (in the viewpoint of the transport service system), the system can use the vectors of driver devices as at least one factor in selecting a driver to perform a transport service.

Methodology

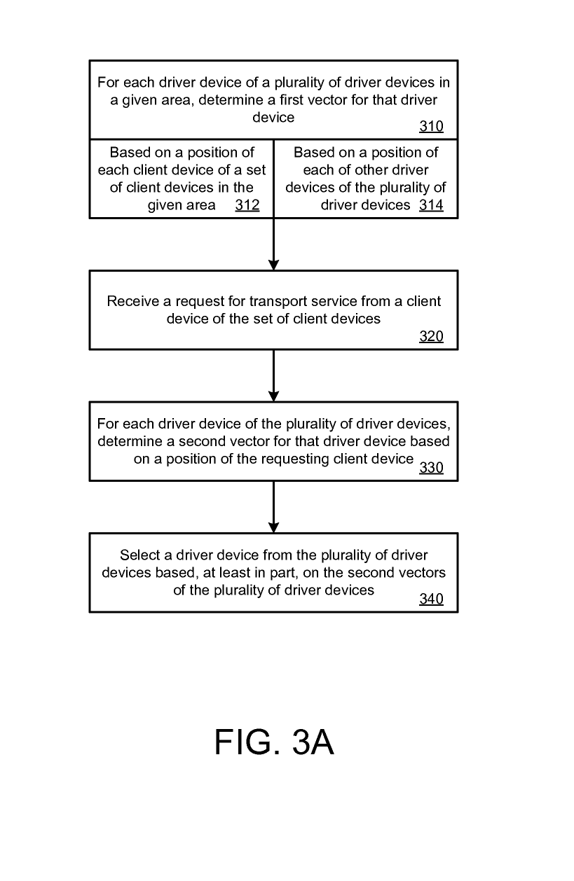

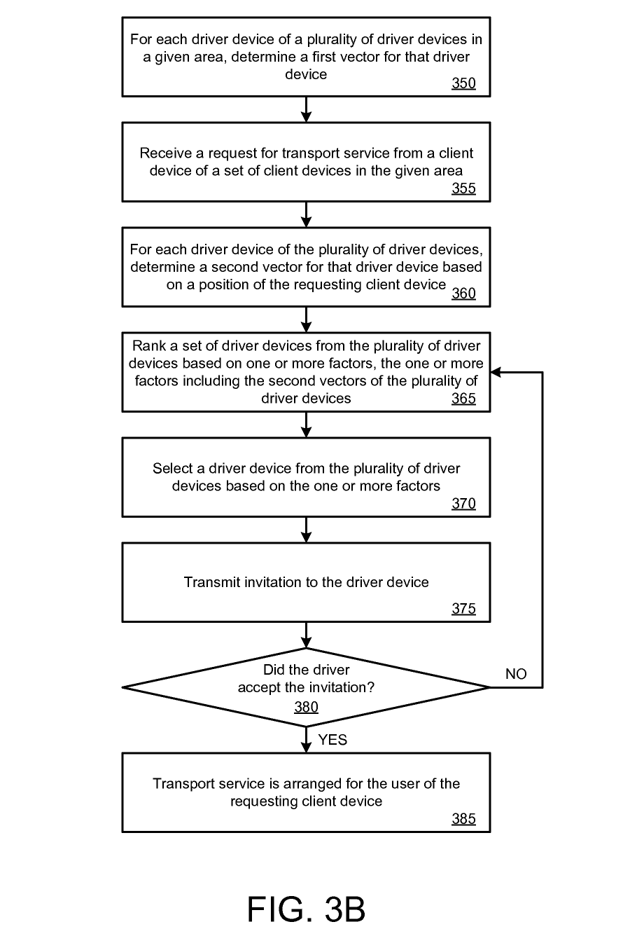

FIGS. 3A and 3B illustrate example methods for arranging an on-demand service for a client, according to some embodiments. Methods such as described by examples of FIGS. 3A and 3B can be implemented using, for example, components described with an example of FIG. 1. Accordingly, references made to elements of FIG. 1 are for purposes of illustrating a suitable element or component for performing a step or sub-step being described.

Referring to FIG. 3A, system 100 can determine, for each driver device of a plurality of driver devices in a given area, a first vector for that driver device (310). System 100 can receive driver information, periodically from individual driver devices in the given area, and client information, periodically from individual client devices in the given area. The driver information and the client information can each include location information about the respective device. Depending on implementation, for each driver device, system 100 can determine a first vector based on a position of each client device of a set of client devices in the given area relative to that driver device (312).

For example, for each first vector of a driver device, the vector calculate 155 of system 100 can determine a set of vectors that are each based on a distance between the position of a client device in the set of client devices and the position of that driver device. According to an example, each of the set of vectors can have (i) a magnitude that is based on the inverse square law, in which the magnitude is related to or equal to the inverse of the square of the distance between the position of a client device and the position of that driver device, and (ii) a direction from the position of that driver device to the position of the client device. In another example, the magnitude can be proportional to the distance. The vector calculate 155 can add each of the set of vectors together to result in the first vector for that driver device.

In another implementation, for each driver device, the first vector can also be based on a position of each of the other driver devices of the plurality of driver devices in the given area. For example, for each first vector of a driver device, the vector calculate 155 can determine a first set of vectors that are based on a distance between the positions of client devices and the position of that driver device (such as discussed above), and determine a second set of vectors that are each based on a distance between the position of that driver device and a position of each of the other driver devices of the plurality of driver devices. According to one vector computation, each of the second set of vectors can have (i) a magnitude that is based on the inverse square law, in which the magnitude is related to or equal to the inverse of the square of the distance between the position of that driver device and a position of the other driver device, and (ii) a direction that is opposite (e.g., 180 degrees) of the direction from the position of that driver device to the position of the other driver device (e.g., to represent the repulsive force away from the other driver device). In another example, the magnitude can be proportional to the distance. The vector calculate 155 can add each of the first set of vectors and the second set of vectors together to result in the first vector for that driver device.

System 100 can continuously compute the first vectors for each of the driver devices in the given area, to reflect changes to real-time information about client devices and driver devices in the given area. System 100 can receive a request for transport service from a client device of the set of client devices (e.g., the requesting client device) (320). The request for transport service can include a client ID, a client device ID, a pickup location (e.g., a GPS position corresponding to a location where the client would like to be picked up), and/or a destination location. The dispatch manage 110 can create a record for the transport service for the client operating the requesting client device.

Based on (or in response to) system 100 receiving the request, system 100 can determine, for each driver device of the plurality of driver devices in the given area, a second vector for that driver device that is based on (i) the first computed vector for that driver device, and (ii) a position of the requesting client device (330). In many cases, the position of the requesting client device is substantially close to (e.g., within a certain predefined threshold distance from) the pickup location indicated by the requesting client device in the request for transport. In one example, if the position of the requesting client device is different than the pickup location for the requesting client device, the vector calculate 155 can perform a vector computation of the first vectors for the driver devices in the given area using the position of the client devices in the given area as well as the pickup location/position of the requesting client device, and then perform a vector computation for the second vectors for the driver devices using the first computed vectors and the pickup location/position of the requesting client device.

According to some examples, for each driver device, the vector calculate 155 can determine the second vector by (i) determining a unit vector in a direction from the position of that driver device to the position of the requesting client device (or the pickup location requested by the requesting client device), and (ii) multiplying the first vector of that driver device with the unit vector. The multiplication process of the first vector and the unit vector can correspond to a vector dot product operation to determine the magnitude of the second vector. The second vector can then be determined to have the computed magnitude and have a direction from the position of that driver device to the position of the requesting client device (note that if the magnitude is a negative scalar value, then the direction of the second vector will be in the opposite direction).

Based on the determined second vectors of the driver devices in the given area, system 100 can select a driver device to provide the transport service to the requesting client operating the requesting client device (340). For example, system 100 can select the driver device having the greatest magnitude (e.g., the largest positive magnitude) of the second vector. In other examples, system 100 can use the magnitudes as one of many factors to select the driver device.

FIG. 3B illustrates another example method for arranging an on-demand service for a client. In FIG. 3B, system 100 can determine, for each driver device of a plurality of driver devices in a given area, a first vector for that driver device (350). For a driver device in a given area, the first vector can be based on a position of a set of client devices and/or a position of other driver devices in the given area (e.g., such as discussed above with FIG. 3A). System 100 can receive a request for transport service from a client device (e.g., the requesting client device) of the set of client devices in the given area (355). In response to receiving the request, system 100 can determine, for each driver device of the plurality of driver devices, a second vector for that driver device based on a position of the requesting client device (360). The second vector for that driver device can also be based on the first computed vector (e.g., such as discussed above with FIG. 3A).

System 100 can rank at least a set of driver devices (of the plurality of driver devices) based on one or more factors, where the one or more factors includes information relating to the second vectors of the plurality of driver devices (365). For example, four different factors can be used to perform a ranking, with each driver device in the set being given a number or ranking value. In addition, in some examples, each of the factors can be provided a weighting value or amount to weight one factor more or less than another factor(s). Such weights and selection of factors for performing the ranking can be user-configurable by an administrative user, for example, of system 100. In other examples, the weights and/or factors used for performing the ranking can be determined based on a machine-learning process (e.g., a learning algorithm) to optimize for a feature, such as for whole-system efficiency.

Using the ranking, system 100 can select a driver device from the set (or plurality) of driver devices in the given area (370). The selected driver device can be the one having the highest ranking. System 100 transmits an invitation to the selected driver device to invite the driver operating that device to either accept, decline, or ignore the invitation (375). System 100 can determine whether the selected driver accepted the invitation (380). For example, system 100 can determine that the selected driver did not accept the invitation if it receives a rejection message or does not receive an acceptance from the driver device within a predefined time after sending the invitation (e.g., ten seconds). If the selected driver does not accept the invitation, in one example, system 100 can select the next highest ranked river device, and transmit an invitation to this device.

In another example, such as illustrated in FIG. 3B, system 100 can perform another ranking operation to rank at least the set of driver devices (excluding the previously selected driver device that did not accept the previous invitation) using the most updated or real-time conditions of the driver devices and client devices in the given area (365). As an addition or an alternative, system 100 can also perform vector calculations of the first and second vectors of the driver devices in the given area (excluding the previously selected driver device) and then use the recomputed vectors for performing the ranking operation. When a selected driver device accepts the invitation, system 100 can then arrange the transport service for the requesting client device (385). For example, system 100 can provide a message to the requesting client device that a driver has been selected for the client and provide information about the selected driver.

Hardware Diagrams

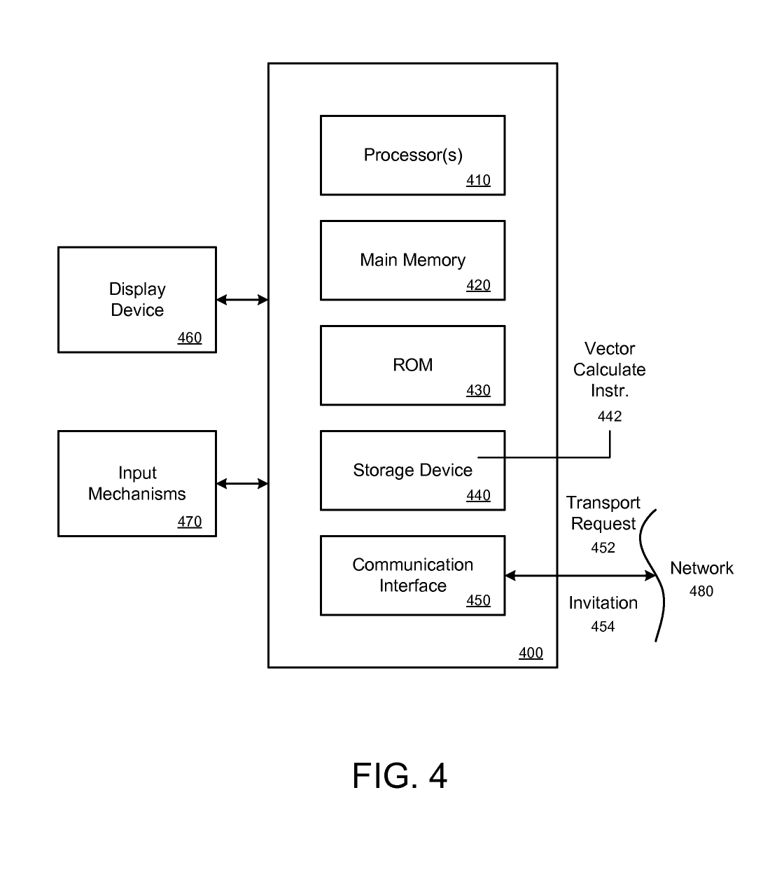

FIG. 4 is a block diagram that illustrates a computer system upon which embodiments described herein may be implemented. For example, in the context of FIG. 1, system 100 may be implemented using a computer system such as described by FIG. 4. System 100 may also be implemented using a combination of multiple computer systems as described by FIG. 4.

In one implementation, computer system 400 includes processing resources 410, main memory 420, ROM 430, storage device 440, and communication interface 450. Computer system 400 includes at least one processor 410 for processing information, and a main memory 420, such as a random access memory (RAM) or other dynamic storage device, for storing information and instructions to be executed by the processor 410. Main memory 420 may also be used for storing temporary variables or other intermediate information during execution of instructions to be executed by the processor(s) 410 (e.g., such as a central processing unit and a graphics processing unit). Computer system 400 may also include a read only memory (ROM) 430 or other static storage device for storing static information and instructions for processor 410. A storage device 440, such as a magnetic disk or optical disk, is provided for storing information and instructions, such as the vector calculate instructions 442 for implementing one or more components discussed with respect to system 100.

The communication interface 450 can enable computer system 400 to communicate with one or more networks 480 (e.g., cellular network) through use of the network link (wireless or wireline). Using the network link, the computer system 400 can communicate with one or more computing devices, and one or more servers. For example, computer system 400 can receive a transport request 452 from a client device via the network link. The transport request 452 can include the client ID, the client device ID, a pickup location, a destination location, and/or a vehicle type selection. Similarly, computer system 400 can provide an invitation message 454 to a selected driver device to invite the driver operating the selected driver device to provide the transport service for the client.

Computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460.

Examples described herein are related to the use of computer system 400 for implementing the techniques described herein. According to one embodiment, those techniques are performed by computer system 400 in response to processor 410 executing one or more sequences of one or more instructions contained in main memory 420. Such instructions may be read into main memory 420 from another machine-readable medium, such as storage device 440. Execution of the sequences of instructions contained in main memory 420 causes processor 410 to perform the process steps described herein (e.g., vector calculate instructions 442). In alternative implementations, hard-wired circuitry may be used in place of or in combination with software instructions to implement examples described herein. Thus, the examples described are not limited to any specific combination of hardware circuitry and software.

As an addition or an alternative, computer system 400 can perform steps described with respect to FIGS. 1 through 3B, for example, using multiple processors 410. For example, a first processor, such as a central processing unit (CPU), can execute instructions for implementing components of the transport service system, such as the dispatch manage 110 and/or the ranking component 160 of FIG. 1. A second processor, such as a graphics processing unit (GPU), can be used by computer system 400 to perform computations for the vectors associated with driver devices, such as described in FIGS. 1 through 3B. In one example, the GPU can execute instructions, such as vector calculate instructions 442, to implement the vector calculate component 155 of FIG. 1. The GPU can have its own dedicated memory resource for storing instructions for performing the vector calculate instructions 442 and/or for storing the vectors calculated for the driver devices.

Typically, a GPU is used for creating graphics or images to be outputted to a display device, such as the display device 460. Computer system 400 can leverage the operational capabilities of the GPU to cause the GPU to perform (e.g., in parallel) the vector computations for system 100. For example, the GPU can continuously compute the first vectors for a plurality of driver devices in a given area (via instructions provided to the GPU by the CPU and/or instructions executed from memory by the GPU), such as described in FIGS. 1 through 3B. The GPU can receive information, such as the locations, of the available driver devices and the client devices in the given area. In addition, in some examples, the GPU can compute the second vectors for the plurality of driver devices in response to receiving a command and/or information from the CPU, that instruct the GPU to calculate the second vectors based on the location of the requesting client device.

For example, the GPU can use a 32-bit red green blue alpha (RGBA) color space or model for purposes of generating images. In such case, 8 bits are used for each of red, green, blue, and alpha (which is typically used for opacity or transparency) for an individual pixel. In some examples, for each driver device in a given area, the GPU can store the first computed vector (e.g., relative to the position of that driver device) as a latitude value and a longitude value in a field of the 32-bit color space. For example, for a first driver device, the first vector can have a first magnitude and a first direction relative to that first driver device. Such a first vector for that first driver device can be represented as a latitude value and a longitude value relative to the position of that first driver device. The latitude value can be stored across 16 bits, such as, in the 8 bits for red and the 8 bits for green, while the longitude value can be stored across 16 bits, such as in the 8 bits for blue and the 8 bits for alpha. In other implementations, only two sets of 8 bits may be used to store a latitude value and a longitude value associated with a driver device, or a 16-bit RGBA color space model may be used.

According to some examples, the GPU can determine a first texture in the 32-bit RGBA color space for the first vectors of the plurality of driver devices in the given area, and continuously update the first vectors (e.g., update the first texture for the first vectors), as discussed above with respect to FIGS. 1 through 3B. Each driver device of the plurality of driver devices can correspond to a pixel in a bit map. When computer system 400 receives a transport request 452 from a client device of the set of client devices in the given area, the CPU can provide the location information (e.g., the latitude and the longitude of the client device) to the GPU and instruct the GPU to compute the second vectors for the plurality of driver devices based on the requesting client device. The GPU can determine a second texture in the 32-bit RGBA color space corresponding to the respective unit vectors for the respective driver devices, as discussed with respect to FIGS. 1 through 3B, and then perform a computation using the first texture and the second texture to determine a third texture in the 32-bit RGBA color space for the second vectors of the plurality of driver devices in the given area, as discussed with respect to FIGS. 1 through 3B.

The GPU can provide, to the CPU, information about the second vectors (e.g., the magnitudes of the second vectors) of the plurality of driver devices from the third texture in the 32-bit RGBA color space. The CPU can then execute instructions to (i) perform the ranking process for the plurality of driver devices in the given area based on one or more factors, including the information about the second vectors of the plurality of driver devices, and (ii) select a driver device for the client operating the requesting client device. Depending on implementation, in another example, the CPU and GPU of computer system 400 can perform vector calculations together, while in other examples, the CPU can perform vector calculations without use of the GPU.

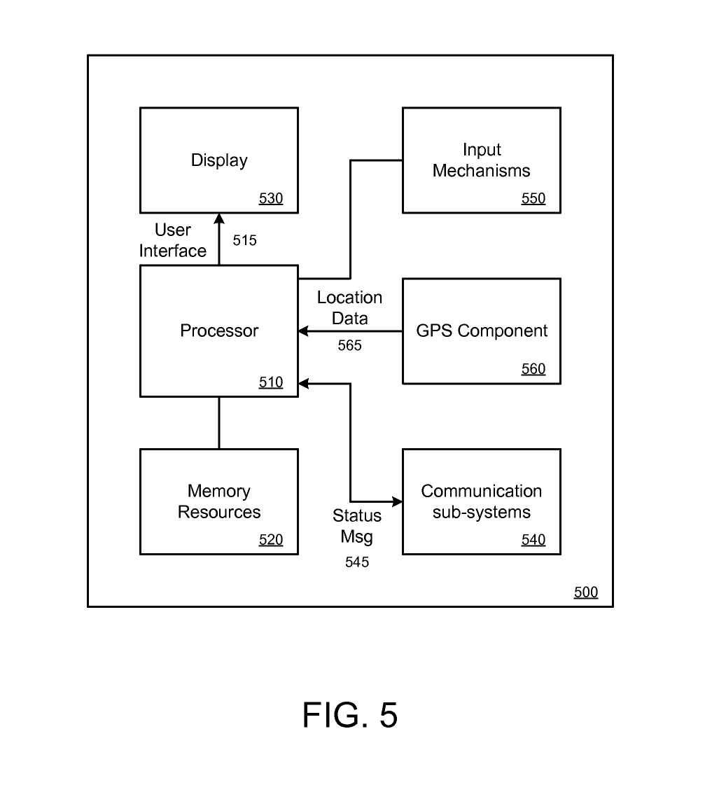

FIG. 5 is a block diagram that illustrates a mobile computing device upon which embodiments described herein may be implemented. In one embodiment, a computing device 500 may correspond to a mobile computing device, such as a cellular device that is capable of telephony, messaging, and data services. The computing device 500 can correspond to a client device or a driver device. Examples of such devices include smartphones, handsets or tablet devices for cellular carriers. The computing device 500 includes a processor 510, memory resources 520, a display device 530 (e.g., such as a touch-sensitive display device), one or more communication sub-systems 540 (including wireless communication sub-systems), input mechanisms 550 (e.g., an input mechanism can include or be part of the touch-sensitive display device), and one or more location detection mechanisms (e.g., GPS component) 570. In one example, at least one of the communication sub-systems 540 sends and receives cellular data over data channels and voice channels.

The processor 510 is configured with software and/or other logic to perform one or more processes, steps and other functions described with implementations, such as described by FIGS. 1 through 3B, and elsewhere in the application. Processor 510 is configured, with instructions and data stored in the memory resources 520, to operate a service application as described in FIGS. 1 through 3B. For example, instructions for operating the service application in order to display user interfaces 515 can be stored in the memory resources 520 of the computing device 500.

A client can operate a client device (such as the computing device 500) to operate a service application to view information about transport services, to provide location information about the client device, and to make a request for a transport service. Similarly, a driver can operate a driver device (such as the computing device 500) to operate a driver's service application to provide information about the driver's status with regards to transport, to provide location information about the driver device, and to accept or reject an invitation for a transport service if the invitation is provided to the driver device from a transport service system.

The computing device 500 can provide a location data point 565, such as a location data point corresponding to the current location of the computing device 500, which can be determined from the GPS component 570. The location data point 565 can be transmitted wirelessly (and periodically) to the transport service system via the communication sub-systems 540 when the service application is operated or running on the computing device 500, such as described with respect to FIGS. 1 through 3B.

The processor 510 can provide a variety of content to the display 530 by executing instructions and/or applications that are stored in the memory resources 520, such as instructions corresponding to the service application. One or more user interfaces 515 can be provided by the processor 510, such as a user interface for the service application, which can include the information corresponding to the status message 545. A status message 545 can correspond to an invitation, in context of a driver device, or can correspond to a message notifying a requesting client that a driver has been selected to provide transport, in context of a client device 9. While FIG. 5 is illustrated for a mobile computing device, one or more embodiments may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other example, even if the other features and examples make no mentioned of the particular feature. Thus, the absence of describing combinations should not preclude from claiming rights to such combinations.

What is being claimed is:

1. A method for arranging a transport service, the method being performed by one or more processors of a computing device and comprising:
for each driver device of a plurality of driver devices in a given area, determining, using the one or more processors, a first vector for that driver device based, at least in part, on a position of each client device of a set of client devices in the given area relative to that driver device, each first vector having a first magnitude and a first direction from a position of that driver device;
receiving, over one or more networks, a request for transport service from a client device of the set of client devices;
for each driver device of the plurality of driver devices, determining, using the one or more processors, a second vector for that driver device based on the first vector and a position of the requesting client device, the second vector having a second magnitude and a second direction from the position of that driver device; and
selecting, using the one or more processors, a driver device from the plurality of driver devices to perform the transport service based, at least in part, on the second magnitudes of the second vectors of the plurality of driver devices.

2. The method of claim 1, wherein selecting the driver device to perform the transport service includes:
ranking a set of driver devices from the plurality of driver devices based, at least in part, on the second magnitudes of the second vectors for the set of driver devices; and
selecting the driver device having the highest ranking to perform the transport service.

3. The method of claim 2, wherein ranking the set of driver devices is also based, at least in part, on a rating of each driver operating each of the set of driver devices.

4. The method of claim 2, further comprising:
transmitting, to the selected driver device over the one or more networks, an invitation to accept the request for transport service.

5. The method of claim 4, further comprising:
receiving, from the selected driver device over the one or more networks, a message declining the invitation;
in response to receiving the message, selecting a second driver device having the next highest ranking to perform the transport service; and
transmitting, to the second driver device over the one or more networks, an invitation to accept the request for transport service.

6. The method of claim 1, wherein determining the first vector for each driver device includes:
calculating a set of vectors for that driver device, each vector of the set of vectors being based on a distance between the position of a client device in the set of client devices and the position of that driver device; and
adding each of the set of vectors to determine the first vector for that driver device.

7. The method of claim 1, wherein determining the first vector for each driver device includes:
calculating a first set of vectors for that driver device, each vector of the first set of vectors being based on a distance between the position of a client device in the set of client devices and the position of that driver device;
calculating a second set of vectors for that driver device, each vector in the second set of vectors being based on a distance between the position of that driver device and a position of each of other driver devices of the plurality of driver devices; and
adding each of the first set of vectors and the second set of vectors to determine the first vector for that driver device.

8. The method of claim 1, wherein determining the second vector for each driver device includes:
determining a unit vector in a direction from the position of that driver device to the position of the requesting client device; and
multiplying the first vector with the unit vector to determine the second magnitude of the second vector for that driver device.

9. The method of claim 1, further comprising:
receiving, from each client device of the set of client devices, information corresponding to the position of that client device, each client device providing the information corresponding to the position of that client device to the computing device periodically; and
receiving, from each driver device of the plurality of driver devices, information corresponding to the position of that driver device, each driver device providing the information corresponding to the position of that driver device to the computing device periodically.

10. A non-transitory computer-readable medium storing instructions that, when executed by one or more processors of a computing device, causes the computing device to perform operations comprising:
for each driver device of a plurality of driver devices in a given area, determining a first vector for that driver device based, at least in part, on a position of each client device of a set of client devices in the given area relative to that driver device, each first vector having a first magnitude and a first direction from a position of that driver device;
receiving, over one or more networks, a request for transport service from a client device of the set of client devices;
for each driver device of the plurality of driver devices, determining a second vector for that driver device based on the first vector and a position of the requesting client device, the second vector having a second magnitude and a second direction from the position of that driver device; and
selecting a driver device from the plurality of driver devices to perform the transport service based, at least in part, on the second magnitudes of the second vectors of the plurality of driver devices.

11. The non-transitory computer-readable medium of claim 10, wherein the instructions cause the computing device to select the driver device to perform the transport service by:
ranking a set of driver devices from the plurality of driver devices based, at least in part, on the second magnitudes of the second vectors for the set of driver devices; and
selecting the driver device having the highest ranking to perform the transport service.

12. The non-transitory computer-readable medium of claim 11, wherein ranking the set of driver devices is also based, at least in part, on a rating of each driver operating each of the set of driver devices.

13. The non-transitory computer-readable medium of claim 11, wherein the instructions cause the computing device to further perform operations comprising:
transmitting, to the selected driver device over the one or more networks, an invitation to accept the request for transport service.

14. The non-transitory computer-readable medium of claim 13, wherein the instructions cause the computing device to further perform operations comprising:
receiving, from the selected driver device over the one or more networks, a message declining the invitation;
in response to receiving the message, selecting a second driver device having the next highest ranking to perform the transport service; and
transmitting, to the second driver device over the one or more networks, an invitation to accept the request for transport service.

15. The non-transitory computer-readable medium of claim 10, wherein the instructions cause the computing device to determine the first vector for each driver device by:
calculating a set of vectors for that driver device, each vector of the set of vectors being based on a distance between the position of a client device in the set of client devices and the position of that driver device; and
adding each of the set of vectors to determine the first vector for that driver device.

16. The non-transitory computer-readable medium of claim 10, wherein the instructions cause the computing device to determine the first vector for each driver device by:
calculating a first set of vectors for that driver device, each vector of the first set of vectors being based on a distance between the position of a client device in the set of client devices and the position of that driver device;
calculating a second set of vectors for that driver device, each vector in the second set of vectors being based on a distance between the position of that driver device and a position of each of other driver devices of the plurality of driver devices; and
adding each of the first set of vectors and the second set of vectors to determine the first vector for that driver device.

17. The non-transitory computer-readable medium of claim 10, wherein the instructions cause the computing device to determine the second vector for each driver device by:
determining a unit vector in a direction from the position of that driver device to the position of the requesting client device; and
multiplying the first vector with the unit vector to determine the second magnitude of the second vector for that driver device.

18. The non-transitory computer-readable medium of claim 10, wherein the instructions cause the computing device to further perform operations comprising:
receiving, from each client device of the set of client devices, information corresponding to the position of that client device, each client device providing the information corresponding to the position of that client device to the computing device periodically; and
receiving, from each driver device of the plurality of driver devices, information corresponding to the position of that driver device, each driver device providing the information corresponding to the position of that driver device to the computing device periodically.

19. A computing device, comprising:
a communication interface to communicate with a plurality of driver devices and a set of client devices in a given area over one or more networks;
a memory storing instructions; and
one or more processors, coupled to the communication interface and the memory, to execute the instructions, wherein the instructions, when executed, causes the computing device to:
for each driver device of a plurality of driver devices in a given area, determine a first vector for that driver device based, at least in part, on a position of each client device of a set of client devices in the given area relative to that driver device, each first vector having a first magnitude and a first direction from a position of that driver device;
receive, over the one or more networks, a request for transport service from a client device of the set of client devices;
for each driver device of the plurality of driver devices, determine a second vector for that driver device based on the first vector and a position of the requesting client device, the second vector having a second magnitude and a second direction from the position of that driver device; and
select a driver device from the plurality of driver devices to perform the transport service based, at least in part, on the second magnitudes of the second vectors of the plurality of driver devices.

20. The computing device of claim 19, wherein the instructions cause the computing device to determine the first vector for each driver device by:
calculating a first set of vectors for that driver device, each vector of the first set of vectors being based on a distance between the position of a client device in the set of client devices and the position of that driver device;
calculating a second set of vectors for that driver device, each vector in the second set of vectors being based on a distance between the position of that driver device and a position of each of other driver devices of the plurality of driver devices; and
adding each of the first set of vectors and the second set of vectors to determine the first vector for that driver device.
